(19) United States
(12) Patent Application Publication
(10) Pub. No.: US 2024/0409119 A1
(43) Pub. Date: Dec. 12, 2024

(54) VEHICLE CONTROL DEVICE, VEHICLE CONTROL METHOD, RECORDING MEDIUM ON WHICH A VEHICLE CONTROL PROGRAM IS RECORDED, AND VEHICLE

(71) Applicant: TOYOTA JIDOSHA KABUSHIKI KAISHA, Toyota-shi (JP)

(72) Inventors: Toko TAGA, Toyota-shi (JP); Yasuaki IIjima, Nagoya-shi (JP); Moto Takabatake, Mountain View, CA (US)

(73) Assignee: TOYOTA JIDOSHA KABUSHIKI KAISHA, Toyota-shi (JP)

(21) Appl. No.: 18/650,740

(22) Filed: Apr. 30, 2024

(30) Foreign Application Priority Data
Jun. 7, 2023 (JP) 2023-094419

(51) Int. Cl. B60W 60/00

(52) U.S. Cl. CPC B60W 60/001; B60W 2300/00

(57) ABSTRACT

A vehicle control device acquires ID information output from a terminal installed at a traveling subject vehicle. The vehicle control device, on the basis of the acquired ID information, specifies vehicle information associated with the ID information in advance, and enable the specified vehicle information. The vehicle control device controls the traveling subject vehicle on the basis of the vehicle information that has been made enabled.

### CROSS-REFERENCE TO RELATED APPLICATION

This application is based on and claims priority under 35 USC 119 from Japanese Patent Application No. 2023-094419 filed on Jun. 7, 2023, the disclosure of which is incorporated by reference herein.

### BACKGROUND

### Technical Field

The present disclosure relates to a vehicle control device, a vehicle control method, a recording medium on which a vehicle control program is recorded, and a vehicle.

### Related Art

Japanese Patent Application Laid-Open (JP-A) No. 2007-245912 (refer to the Abstract thereof, for example) discloses a proximity ID control device that receives set information transmitted from a proximity ID portable communication terminal, and that, by controlling the display of an onboard device or a display device on the basis of the received set information, improves the convenience for a user utilizing a vehicle.

It is preferable to be able to change not only the display specifications of a display device within a vehicle, but also other specifications of the vehicle. Although the technique disclosed in JP-A No. 2007-245912 is a technique in which a user can adjust a display device within a vehicle so as to suit his/her preferences, the changing of other specifications of the vehicle is not considered.

In view of the above-described circumstances, an object of the present disclosure is to provide a vehicle control device, a vehicle control method, a vehicle control program, and a vehicle that can change various specifications of a traveling subject vehicle.

### SUMMARY

A vehicle control device relating to a first aspect is a vehicle control device including: an acquiring section acquiring ID information output from a terminal installed at a traveling subject vehicle; a specifying section that, on the basis of the ID information acquired by the acquiring section, specifies vehicle information associated with the ID information in advance, and enables the specified vehicle information; and a control section controlling the traveling subject vehicle on the basis of the vehicle information that was made enabled by the specifying section.

The vehicle control device acquires ID information output from a terminal that has been installed at a traveling subject vehicle. On the basis of the acquired ID information, the vehicle control device specifies vehicle information associated with that ID information in advance, and enables the specified vehicle information. The vehicle control device controls the traveling subject vehicle on the basis of the vehicle information that has been made enabled. Due thereto, various specifications of the traveling subject vehicle can be changed.

In a vehicle control device of a second aspect, in the vehicle control device of the first aspect, the vehicle information comprises driving characteristics information that expresses driving characteristics of a vehicle, and, based on the acquired ID information, the specifying section specifies a vehicle type that is a reproduction target expressed by the ID information, and, by reflecting the driving characteristics information, which corresponds to the specified vehicle type of the reproduction target, in the driving characteristics information of the traveling subject vehicle, the specifying section enables the driving characteristics information, and the control section controls the traveling subject vehicle on the basis of the driving characteristics information that has been made enabled. Due thereto, the driving characteristics information, which corresponds to the vehicle type that is a reproduction target, is reproduced, and the traveling subject vehicle can be made to travel in accordance with the reproduced driving characteristics information.

In a vehicle control device of a third aspect, in the vehicle control device of the first or second aspect, the traveling subject vehicle is an electric vehicle, and information relating to acceleration response characteristics is included in the driving characteristics information. Due thereto, the acceleration response characteristics, associated with the vehicle type that is a reproduction target, are reproduced, and the traveling subject vehicle can be made to travel in accordance with the reproduced acceleration response characteristics.

In a vehicle control device of a fourth aspect, in the vehicle control device of any one of the first through third aspects, the traveling subject vehicle is an electric vehicle, and information regarding a gear ratio of a manual transmission is included in the driving characteristics information. Due thereto, the gear ratio of the manual transmission, which corresponds to the vehicle type that is a reproduction target, is reproduced, and the traveling subject vehicle can be made to travel in accordance with the reproduced gear ratio of the manual transmission.

In a vehicle control device of a fifth aspect, in the vehicle control device of any one of the first through fourth aspects, in a case in which at least two items of the ID information have been acquired by the acquiring section, a combination of the driving characteristics information, associated with first ID information among the two items of ID information, and the driving characteristics information, associated with second ID information among the two items of ID information, is reflected in driving characteristics information of the traveling subject vehicle. Due thereto, a combination of plural driving characteristics information is reproduced, and the traveling subject vehicle can be made to travel in accordance with the reproduced driving characteristics information.

A vehicle control device of a sixth aspect further includes, in the vehicle control device of any one of the first through fifth aspects, a storage in which plural items of vehicle information are stored in advance, wherein the specifying section is structured so as to, among the plural items of vehicle information, enable the vehicle information that was associated with the ID information in advance. Due thereto, it is possible to enable only the vehicle information that is a reproduction target.

A vehicle control device of a seventh aspect further includes, in the vehicle control device of any one of the first through sixth aspects, a storage in which plural items of the vehicle information are stored in advance, wherein each of the plural items vehicle information stored in the storage is information that was downloaded in advance from a server before the terminal was installed at the traveling subject vehicle. Due thereto, for example, by downloading in advance vehicle information that have large data amounts, the vehicle information can be utilized immediately without the need to download vehicle information later.

A vehicle control device of an eighth aspect further includes, in the vehicle control device of any one of the first through seventh aspects, a storage in which plural items of vehicle information are stored in advance, wherein the plural items of vehicle information are respectively stored in the storage at different timings from each other, and, in a case in which driving characteristics information, which are associated with the vehicle type corresponding to the ID information acquired by the acquiring section, is not stored in the storage, the specifying section transmits an instruction signal to a server, and, in response to receipt of the instruction signal, the server transmits, to the vehicle control device, the driving characteristics information associated with the vehicle type associated with the ID information acquired by the acquiring section, and the specifying section enables the driving characteristics information, which was transmitted from the server. Due thereto, even if the vehicle information that is the object is not stored in the storage, the vehicle information that is the object can be acquired later.

In a vehicle control device of a ninth aspect, in the vehicle control device of any one of the first through eighth aspects, the terminal is a toy that is equipped with an ID tag and that models a vehicle. Due thereto, vehicle information of the traveling subject vehicle can be set in accordance with the type of the toy that models a vehicle.

A vehicle control device of a tenth aspect is a vehicle control device wherein the terminal is a portable terminal. Due thereto, vehicle information of the traveling subject vehicle can be set in accordance with the type of information output from the portable terminal.

A vehicle of an eleventh aspect is a vehicle that includes the vehicle control device of any one of the first through eighth aspects. Due thereto, various specifications of the traveling subject vehicle can be changed.

A vehicle control method of a twelfth aspect is a vehicle control method in which a computer executes processings of: acquiring ID information output from a terminal installed at a traveling subject vehicle; on the basis of the acquired ID information, specifying vehicle information associated with the ID information in advance, and enabling the specified vehicle information; and controlling the traveling subject vehicle on the basis of the vehicle information that has been made enabled. Due thereto, in the same way as in the first aspect, various specifications of the traveling subject vehicle can be changed.

A recording medium, on which a vehicle control program is recorded, of a thirteenth aspect is a vehicle control program for causing a computer to execute processings of: acquiring ID information output from a terminal installed at a traveling subject vehicle; on the basis of the acquired ID information, specifying vehicle information associated with the ID information in advance, and enabling the specified vehicle information; and controlling the traveling subject vehicle on the basis of the vehicle information that has been made enabled. Due thereto, in the same way as in the first aspect, various specifications of the traveling subject vehicle can be changed.

As described above, in accordance with the present disclosure, there is the effect that various specifications of a traveling subject vehicle can be changed.

### BRIEF DESCRIPTION OF THE DRAWINGS

FIG. 1A is an explanatory drawing for explaining an overview of an embodiment;

FIG. 1B is an explanatory drawing for explaining an overview of an embodiment;

FIG. 1C is an explanatory drawing for explaining an overview of an embodiment;

FIG. 2 is a schematic block drawing of a vehicle control system relating to the embodiment;

FIG. 3 is a drawing for explaining an example of information stored in an information storing section;

FIG. 4 is a drawing illustrating an example of the structure of a computer of a vehicle control device; and

FIG. 5 is a flowchart illustrating an example of processing carried out at the vehicle control device relating to the embodiment.

### DETAILED DESCRIPTION

### Embodiments

A vehicle control device of an embodiment is described hereinafter by using the drawings. Note that, in the present embodiment, explanation is given by using, as an example, a case in which a traveling subject vehicle is an electric vehicle. Examples of electric vehicles to which the vehicle control device of the present embodiment can be applied are battery electric vehicles (BEVs), plug-in hybrid electric vehicles (PHEVs), hybrid electric vehicles (HEVs), and the like.

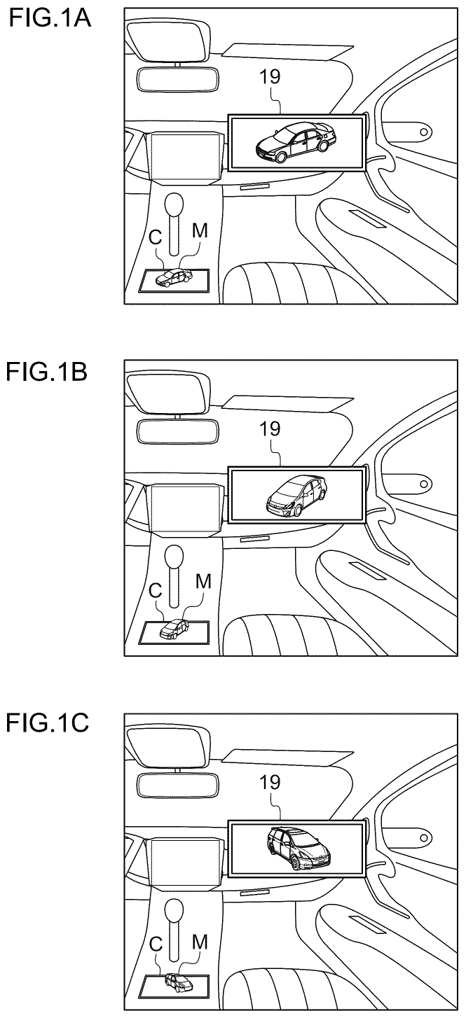

FIG. 1A, FIG. 1B, and FIG. 1C are a drawing for explaining the present embodiment. As illustrated in FIG. 1A, FIG. 1B, and FIG. 1C, in a case in which a toy M (hereinafter also simply called minicar M) that models a vehicle is placed on a center console C of a traveling subject vehicle, the vehicle control device of the present embodiment (not illustrated) outputs an image of the vehicle modeled by the minicar M to a display device 19 within the traveling subject vehicle, in accordance with ID information outputted by an ID tag (not illustrated) embedded in the toy M. Specifically, as illustrated in FIG. 1A, in a case in which a given minicar M is placed on the center console C, the vehicle control device (not illustrated) causes an image of a vehicle having an appearance similar to that of the minicar M (for example, an image of a sports car whose appearance is similar to that of the minicar M) to be displayed on the display device 19. Further, as illustrated in FIGS. 1B and 1C, in a case in which the minicar M that is different from that illustrated in FIG. 1A is placed on the center console C, the vehicle control device (not illustrated) causes an image of a vehicle whose appearance is similar to that of that minicar M to be displayed on the display device 19.

Moreover, the vehicle control device of the present embodiment changes various specifications of a traveling subject vehicle 12 in accordance with the ID information outputted by the ID tag (not illustrated) embedded in the minicar M. Specifically, the vehicle control device of the present embodiment (not illustrated) causes the vehicle information of the vehicle modeled by the minicar M to be reflected in vehicle information of the traveling subject vehicle 12. For example, in a case in which a vehicle occupant places the minicar M on the center console C, driving specifying characteristics/operation information of the vehicle that that minicar M models is reflected in the driving characteristics/operation information of the traveling subject vehicle 12. More specifically, for example, the acceleration response characteristics of the vehicle modeled by the minicar M are reflected in the acceleration response characteristics of the traveling subject vehicle 12. Due thereto, various specifications relating to traveling of the traveling subject vehicle can be changed. Further, the vehicle occupant can enjoy the driving characteristics of the traveling subject vehicle 12. Specifics are described hereinafter.

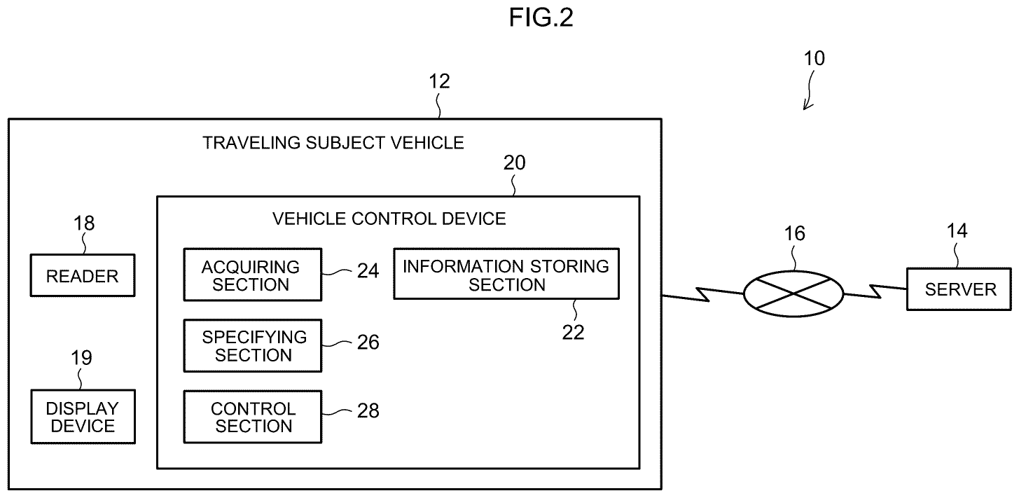

FIG. 2 is a block drawing illustrating an example of the structure of a vehicle control system 10 relating to the embodiment. As illustrated in FIG. 2, the vehicle control system 10 has the traveling subject vehicle 12 and a server 14. The traveling subject vehicle 12 has a reader 18, the display device 19, and a vehicle control device 20. The traveling subject vehicle 12 and the server 14 are connected by a predetermined network 16 so as to be able to communicate with one another.

### (Reader)

The reader 18 is set at a predetermined place of the traveling subject vehicle 12. For example, the reader 18 is set at the interior of the center console C illustrated in FIG. 1A, FIG. 1B, and FIG. 1C. The reader 18 reads the ID information outputted by the ID tag that is within the minicar M that is placed on the center console C. Note that the exchanging of data between the reader 18 and the ID tag is carried out by a known short-range communication method.

### (Display Device)

The display device 19 displays various screens in accordance with control of the vehicle control device 20. For example, the display device 19 displays screens such as those illustrated in FIG. 1A, FIG. 1B, and FIG. 1C.

### (Vehicle Control Device)

As illustrated in FIG. 2, the vehicle control device 20 functionally has an information storing section 22, an acquiring section 24, a specifying section 26 and a control section 28.

Vehicle information, which are set in correspondence with various types of vehicles, are stored in advance in the information storing section 22. The vehicle information is information relating to the vehicle that the minicar M represents. In the present embodiment, a case in which the vehicle information is driving characteristics information, which expresses driving characteristics of the vehicle, is described as an example. Each of the plural driving characteristics information that are stored in the information storing section 22 is information that has been downloaded in advance from the server 14, before the minicar M is installed at the traveling subject vehicle 12.

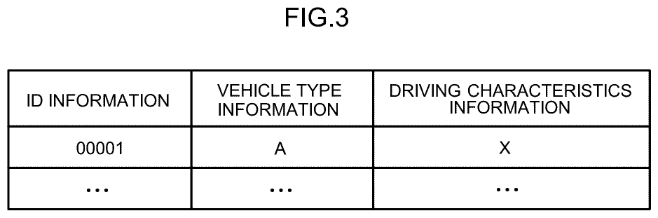

FIG. 3 is a drawing illustrating an example of information stored in the information storing section 22. As illustrated in FIG. 3, for each of plural ID information, the ID information, vehicle type information, and driving characteristics information are stored in correspondence with one another in the information storing section 22. The vehicle type information is information expressing the type of the vehicle corresponding to the external appearance of the minicar M. The driving characteristics information is information expressing the driving characteristics of vehicles belonging to the vehicle type that corresponds to the minicar M. For example, information relating to the acceleration response characteristics, information of the gear ratio of the manual transmission, and the like are included as the driving characteristics information.

For example, in a case in which vehicle type “A”, which corresponds to ID information “00001” illustrated in FIG. 3, expresses a given sports car, driving characteristics information “X” of that sports car is stored in the information storing section 22 in correspondence with ID information “00001” and vehicle type “A”.

The acquiring section 24 acquires the ID information outputted from the minicar M that has been installed at the traveling subject vehicle 12. Specifically, the acquiring section 24 acquires the ID information that is read by the reader 18.

On the basis of the ID information acquired by the acquiring section 24, the specifying section 26 specifies the driving characteristics information that was set in correspondence with that ID information in advance. Next, the specifying section 26 enables the specified driving characteristics information.

More specifically, on the basis of the acquired ID information, the specifying section 26 specifies the vehicle type that is a reproduction target expressed by that ID information. Then, by reflecting the driving characteristics information, which corresponds to the specified vehicle type that is the reproduction target, in the driving characteristics information of the traveling subject vehicle 12, the specifying section 26 enables the driving characteristics information corresponding to the specified vehicle type of the reproduction target.

The control section 28 controls the traveling subject vehicle 12 on the basis of the driving characteristics information that was enabled by the specifying section 26.

For example, in a case in which the ID information acquired by the acquiring section 24 is “00001”, by referring to the information storing section 22, the specifying section 26 specifies vehicle type A that is the reproduction target expressed by that ID information “00001”. Then, the specifying section 26 enables the driving characteristics information “X” by reflecting the driving characteristics information “X”, which corresponds to the specified vehicle type “A” that is the reproduction target, in the driving characteristics information of the traveling subject vehicle 12. For example, the acceleration response characteristics of vehicle type “A” that is the reproduction target are reflected in the acceleration response characteristics of the traveling subject vehicle 12. Then, the control section 28 controls the traveling subject vehicle 12 on the basis of the driving characteristics information “X” that was enabled by the specifying section 26.

Due thereto, driving characteristics information “X”, which vehicle type “A” of the vehicle that the minicar M models probably has, is reproduced at the traveling subject vehicle 12. Therefore, the vehicle occupant of the traveling subject vehicle 12 can enjoy those driving characteristics.

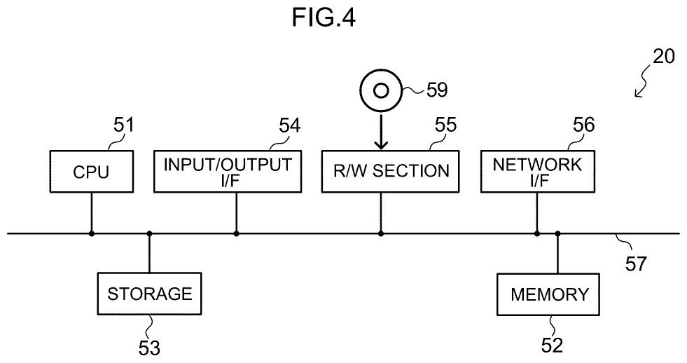

The vehicle control device 20 can be realized by, for example, a computer such as that illustrated in FIG. 4. A computer that realizes the vehicle control device 20 has a CPU 51, a memory 52 serving as a temporary storage region, and a non-volatile storage 53. Further, the computer has an input/output interface (I/F) 54 connected to input/output devices (not illustrated) such as the reader 18 and the display device 19 and the like, and the computer has a read/write (R/W) section 55 that controls the reading and writing of data from and to a recording medium 59. Further, the computer has a network I/F 56 connected to a network such as the internet or the like. The CPU 51, the memory 52, the storage 53, the input/output I/F 54, the R/W section 55 and the network I/F 56 are connected to one another via bus 57.

The storage 53 can be realized by a hard disk drive (HDD), a solid state drive (SDD), a flash memory or the like. A program for causing the computer to function is stored in the storage 53 that serves as a storage medium. The CPU 51 reads-out the program from the storage 53, expands the program in the memory 52, and successively executes the processes of the program.

Operation of the vehicle control system 10 of the embodiment is described next.

When the minicar M is placed at the center console C, the reader 18 reads the ID information outputted from the ID tag of the minicar M. Then, the reader 18 outputs, to the vehicle control device 20, a control signal expressing that ID information has been sensed.

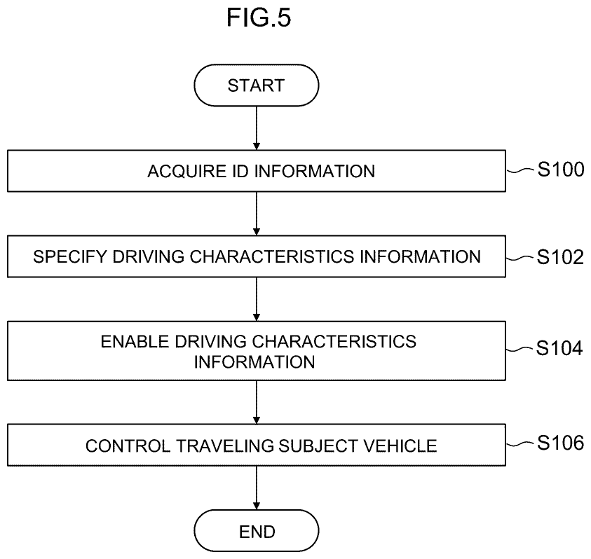

When the vehicle control device 20 receives the control signal outputted from the reader 18, the vehicle control device 20 executes the vehicle control processing routine illustrated in FIG. 5.

In step S100, the acquiring section 24 acquires the ID information read by the reader 18.

In step S102, on the basis of the ID information acquired in step S100, the specifying section 26 specifies the vehicle type information and the driving characteristics information that were set in correspondence in advance with that ID information. Further, the specifying section 26 specifies the specified vehicle type information, and, as illustrated in FIG. 1A, FIG. 1B, and FIG. 1C, causes an image of a vehicle corresponding to that vehicle type information to be displayed on the display device 19.

In step S104, the specifying section 26 enables the driving characteristics information, which was specified in step S102. Note that, at the time of enabling the specified driving characteristics information, for example, the specifying section 26 may cause the display device 19 to display a screen that asks the vehicle occupant whether or not the driving characteristics information of that vehicle type should be enabled, and if an OK instruction is received from the vehicle occupant, the specifying section 26 may enable the specified driving characteristics information.

In step S106, the control section 28 controls the traveling subject vehicle 12 on the basis of the driving characteristics information that was enabled in step S104. Specifically, the control section 28 controls the traveling subject vehicle 12 such that the driving characteristics information that are to be reproduced are reproduced.

As described above, the vehicle control device of the vehicle control system 10 relating to the present embodiment acquires ID information output from a toy that is installed at a traveling subject vehicle. Then, on the basis of the acquired ID information, the vehicle control device specifies the driving characteristics information associated with that ID information in advance, and enables the specified driving characteristics information. The vehicle control device controls the traveling subject vehicle on the basis of the driving characteristics information that has been made enabled. Due thereto, various specifications relating to the traveling of the traveling subject vehicle can be changed. Further, data that is to be reflected in the traveling subject vehicle can be specified by the type of the ID tag.

Further, in accordance with the vehicle control device relating to the present embodiment, by linking external appearances of minicars and driving characteristics with one another, a sense of immersion can be provided to the user who is the vehicle occupant, and the user experience can be improved. Further, in the present embodiment, because the driving characteristics of the vehicle type corresponding to the minicar are reproduced at the traveling subject vehicle, the vehicle occupant can enjoy various driving characteristics. Specifically, the user who is the vehicle occupant can enjoy various driving characteristics by collecting various minicars.

Further, although techniques of enabling changing of the form of the display of the meters and the central display are known as prior art, even if such changes are made, it is difficult to greatly change the impression that is given to the vehicle occupant, and there are cases in which the vehicle occupant grows tired of the form of the display of the meters or the central display. On the other hand, in the case of a usual vehicle, the feeling when riding in the vehicle is always constant, and the vehicle occupant does not get a fresh feel in the driving characteristics. However, in the case of a usual vehicle, there is the problem that, in order to change the feeling at the time of riding in the vehicle, much time and cost are required due to reasons in the manufacturing of the vehicle.

In contrast, in accordance with the vehicle control device relating to the present embodiment, the driving characteristics of the traveling subject vehicle can be changed in accordance with ID information output from an ID tag, and the feeling when riding in the vehicle can be changed easily.

Although the vehicle control system 10 relating to the embodiment has been described above, the technique of the present disclosure can, of course, be implemented in various forms within a scope that does not depart from the gist of the present disclosure.

For example, although the above embodiment describes, as an example, a case in which the terminal that is installed at the traveling subject vehicle 12 is the minicar M, the present disclosure is not limited to this. For example, the terminal that is installed at the traveling subject vehicle 12 may be a portable terminal such as a smartphone or the like.

Further, although the above embodiment describes, as an example, a case in which the vehicle information is driving characteristics information, the present disclosure is not limited to this. Provided that the vehicle information is information that relates to the vehicle and that can be reflected in the traveling subject vehicle 12, the vehicle information may be any type of information. For example, not only the driving characteristics of the vehicle, but also the interior design of the traveling subject vehicle 12 or the engine noise of the traveling subject vehicle 12 may be changed in accordance with the vehicle information. With regard to the interior design of the traveling subject vehicle 12 in this case, for example, the interior design of the traveling subject vehicle 12 is changed by changing the light-emitting elements disposed at respective places in the traveling subject vehicle 12 or the light that is output from the display device. Further, the present embodiment describes, as an example, a case in which the driving characteristics information is information relating to the acceleration response characteristics and the information of the gear ratio of the manual transmission, but the present disclosure is not limited to this. The driving characteristics information may be any information provided that it is information expressing driving characteristics of the vehicle.

Further, the characteristics of the traveling subject vehicle 12 may be changed in accordance with the position of the minicar M at the center console C. For example, if the minicar M is slid forward, the traveling subject vehicle 12 may be controlled such that the inter-vehicle distance between the traveling subject vehicle 12 and the vehicle ahead thereof is reduced. Or, for example, if the minicar M is slid forward, the traveling subject vehicle 12 may enter into an even sportier mode, and the acceleration response characteristics and the like of the traveling subject vehicle 12 may change.

Further, the above embodiment describes, as an example, a case in which the one minicar M is placed on the center console C, and the driving characteristics information corresponding to that minicar M is reflected in the driving characteristics information of the traveling subject vehicle 12. However, the present disclosure is not limited to this. For example, two or more driving characteristics information may be combined and reflected in the driving characteristics information of the traveling subject vehicle 12. For example, in a case in which two of the minicars M are placed on the center console C and at least two ID information are acquired by the acquiring section 24, the combination of the driving characteristics information, which corresponds to a first ID information among the two ID information, and the driving characteristics information, which corresponds to a second ID information among the two ID information, may be reflected in the driving characteristics information of the traveling subject vehicle 12. In this case, for example, the specifying section 26 may cause the acceleration response characteristics of vehicle type A, which corresponds to the first ID information, to be reflected in the traveling subject vehicle 12, and may cause the gear ratio of the manual transmission of the vehicle type B, which corresponds to the second ID information, to be reflected in the traveling subject vehicle 12. Or, the specifying section 26 may cause acceleration response characteristics, which express the average of the acceleration response characteristics of vehicle type A corresponding to the first ID information and the acceleration response characteristics of vehicle type B corresponding to the second ID information, to be reflected in the traveling subject vehicle 12.

Further, the above embodiment describes, as an example, a case in which driving characteristics information that is an example of the vehicle information is stored in advance in the information storing section 22. However, the present disclosure is not limited to this. For example, the times at which plural vehicle information are stored in the information storing section 22 may differ.

For example, in a case in which driving characteristics information, which is associated with the vehicle type that corresponds to the ID information acquired by the acquiring section 24, is not stored in the information storing section 22, the specifying section 26 may download the corresponding driving characteristics information from the server 14. Specifically, in this case, the specifying section 26 transmits an instruction signal to the server 14. Then, in response to the receipt of the instruction signal, the server 14 transmits, to the vehicle control device 20, the driving characteristics information associated with the vehicle type that corresponds to the ID information acquired by the acquiring section 24. Then, the specifying section 26 of the vehicle control device 20 enables the driving characteristics information, which was transmitted from the server 14.

In further detail, for example, at the time when the ID information that is the object is acquired by the acquiring section 24, if vehicle type information corresponding to that ID information is not stored in the information storing section 22, the vehicle control device 20 may download, from the server 14, the combination of that vehicle type information and the driving characteristics information.

Or, for example, in a case in which the vehicle type information corresponding to the ID information acquired by the acquiring section 24 is stored in the information storing section 22, but on the other hand, some of the driving characteristics information corresponding to that vehicle type information are not stored in the information storing section 22, the vehicle control device 20 may download, from the server 14, the driving characteristics information that is not stored in the information storing section 22.

For example, there is a case in which, among the driving characteristics information, information relating to the acceleration response characteristics is stored in the information storing section 22, but the information of the gear ratio of the manual transmission is not stored in the information storing section 22. In this case, at the time when the ID information that is the object is acquired by the acquiring section 24, the vehicle control device 20 may, for example, in response to receipt of an instruction from the user, download the information relating to the gear ratio of the manual transmission from the server 14.

Therefore, it can be made such that, at the time when the user purchases the traveling subject vehicle 12, only the information that have relative large data amounts are stored in the information storing section 22 of the vehicle control device 20, and information that have relatively small amounts are downloaded from the server 14 later.

More specifically, for example, there are various types of vehicle information that are stored in the information storing section 22 of the vehicle control device 20. Examples of vehicle information stored in the information storing section 22 are information relating to the vehicle-human interface, information relating to the driving characteristics, information relating to dial-type operation switches, and the like. The data amounts of these respective information are different. For example, the data amount of information relating to dial-type operation switches is relatively large, and therefore, may be downloaded to the information storing section 22 in advance at the time when the user purchases the traveling subject vehicle 12.

Further, any of various types of processors other than a CPU may execute the processing that is executed due to the CPU reading-in software (a program) in the above-described embodiment. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the processing may be executed by one of these various types of processors, or may be executed by a combination of two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like.

Moreover, although the above-described embodiment is structured such that the various data are stored in a storage, the present disclosure is not limited to this. A recording medium such as, for example, a CD (Compact Disk), a DVD (Digital Versatile Disk), a USB (Universal Serial Bus) memory or the like may be used as the storage. In this case, various programs and data and the like are stored on the recording medium.

All publications, patent applications, and technical standards mentioned in this specification are herein incorporated by reference to the same extent as if each individual publication, patent application, or technical standard was specifically and individually indicated to be incorporated by reference.

What is claimed is:

1. A vehicle control device, comprising an information processing device including a memory and a processor coupled to the memory, wherein the processor is configured to:
acquire ID information output from a terminal installed at a traveling subject vehicle;
on the basis of the acquired ID information, specify vehicle information associated with the ID information in advance, and enable the specified vehicle information; and
control the traveling subject vehicle on the basis of the vehicle information that has been made enabled.

2. The vehicle control device of claim 1, wherein:
the vehicle information comprises driving characteristics information that expresses driving characteristics of a vehicle, and
the processor is configured to:
based on the acquired ID information, specify a vehicle type that is a reproduction target expressed by the ID information, and, by reflecting the driving characteristics information, which corresponds to the specified vehicle type of the reproduction target, in the driving characteristics information of the traveling subject vehicle, enable the driving characteristics information; and
control the traveling subject vehicle on the basis of the driving characteristics information that has been made enabled.

3. The vehicle control device of claim 2, wherein:
the traveling subject vehicle is an electric vehicle, and
information relating to acceleration response characteristics is included in the driving characteristics information.

4. The vehicle control device of claim 2, wherein:
the traveling subject vehicle is an electric vehicle, and
information regarding a gear ratio of a manual transmission is included in the driving characteristics information.

5. The vehicle control device of claim 2, wherein, in a case in which at least two items of the ID information have been acquired, the processor reflects, in the driving characteristics information of the traveling subject vehicle, a combination of driving characteristics information associated with first ID information among the two items of ID information, and driving characteristics information associated with to second ID information among the two items of ID information.

6. The vehicle control device of claim 1, wherein:
a plurality of items of the vehicle information are stored in advance in the memory, and
the processor is configured to, among the plurality of items of vehicle information, enable the vehicle information that was associated with the ID information in advance.

7. The vehicle control device of claim 1, wherein:
a plurality of items of the vehicle information are stored in advance in the memory, and
each of the plurality of items vehicle information stored in the memory is information that was downloaded in advance from a server before the terminal was installed in the traveling subject vehicle.

8. The vehicle control device of claim 1, wherein:
a plurality of items of the vehicle information are stored in advance in the memory,
the plurality of items of vehicle information are respectively stored in the memory at different timings from each other,
in a case in which vehicle information associated with the acquired ID information is not stored in the memory, the processor transmits an instruction signal to a server,
in response to receipt of the instruction signal, the server transmits, to the vehicle control device, the vehicle information associated with the acquired ID information, and
the processor enables the vehicle information transmitted from the server.

9. The vehicle control device of claim 1, wherein the terminal is a toy that is equipped with an ID tag and that models a vehicle.

10. The vehicle control device of claim 1, wherein the terminal is a portable terminal.

11. A vehicle, comprising the vehicle control device of claim 1.

12. A vehicle control method, according to which a processor:
acquires ID information output from a terminal installed at a traveling subject vehicle;
on the basis of the acquired ID information, specifies vehicle information associated with the ID information in advance, and enables the specified vehicle information; and
controls the traveling subject vehicle on the basis of the vehicle information that has been made enabled.

13. A non-transitory recording medium, storing a vehicle control program executable by a computer to perform processing, the processing comprising:
acquiring ID information output from a terminal installed at a traveling subject vehicle;
on the basis of the acquired ID information, specifying vehicle information associated with the ID information in advance, and enabling the specified vehicle information; and
controlling the traveling subject vehicle on the basis of the vehicle information that has been made enabled.
